(19) United States
(12) Patent Application Publication
(10) Pub. No.: US 2012/0021639 A1
(43) Pub. Date: Jan. 26, 2012

(54) Lighted USB

(75) Inventor: Arthur L. Serrano, West Hills, CA (US)

(73) Assignee: EVER WIN INTERNATIONAL CORPORATION, City of Industry, CA (US)

(21) Appl. No.: 12/840,995

(22) Filed: Jul. 21, 2010

(51) Int. Cl. H01R 3/00; B23P 23/00

(52) U.S. Cl. 439/488; 29/401.1

(57) ABSTRACT

An illuminated universal serial bus (USB) port that is illuminated with a light emitting diode (LED). The illuminated USB port comprises a USB port with a LED disposed directly behind the USB port to illuminate the USB port through the opaque white plastic and the existing openings in the USB port. The illuminated USB port is easily located in low light or dark environments. The illuminated USB port can also indicate the power on status of a USB port.

### BACKGROUND

1. Field of Invention

The present invention relates generally to a universal serial bus port that is illuminated. More specifically, the present invention relates to a universal serial bus port that is back lighted with a light emitting diode.

2. Description of Related Art

Universal serial bus (USB) is a specification created around 1996 to establish communication between electronic devices and a host controller. The host controller is usually a computer. USB can carry both power and data. It is intended to replace a variety of serial and parallel ports. USB is used to connect computer peripherals such as mice, keyboards, digital cameras, printers, flash drives, and external hard drives to a computer. It has become a common electronic interface for many modern electronic devices and computers.

The standard female USB port has a rectangular opening with a biased opaque white plastic tongue that is enclosed in a metal sheath. There are four electrical contacts on the opaque white plastic tongue. The four electrical contacts extend through four openings in the back of the opaque white plastic tongue and connect to power and data connections. The standard male USB plug has a compatible plug that can only plug into the female USB port in one orientation.

### BRIEF SUMMARY OF THE INVENTION

The present invention is an illuminated universal serial bus (USB) port that is illuminated with a light emitting diode (LED). The illuminated USB port comprises a female USB port with a LED disposed directly behind the USB port to illuminate the USB port through the white plastic and existing openings in the USB port without modifications to existing USB port design.

An object of the lighted USB is to provide a USB port that is illuminated. A further object of the lighted USB is to provide an illuminated USB port that is easily located in low light or dark environments. An additional object of the lighted USB is to provide a method of illuminating the inside of a USB port without taking up any font panel space when the USB port is mounted. Another object of the lighted USB is to provide a method to retrofit existing USB port designs with an illumination means. Yet another object of the lighted USB is to provide a means to illuminate a USB port through the white plastic and existing openings from behind the USB port without using any light pipes. Another object of the lighted USB is to provide a means to indicate the power on status of a USB port.

### BRIEF DESCRIPTION OF THE DRAWINGS

FIG. 1 shows a perspective view of a preferred embodiment of the lighted USB.

FIG. 2 shows the top view of the preferred embodiment of the lighted USB.

FIG. 3 shows the front view of the preferred embodiment of the lighted USB.

FIG. 4 shows the bottom view of the preferred embodiment of the lighted USB.

FIG. 5 shows the left side view of the preferred embodiment of the lighted USB.

FIG. 6 shows the right side view of the preferred embodiment of the lighted USB.

FIG. 7 shows the rear view of the preferred embodiment of the lighted USB.

FIG. 8 shows the front view of the preferred embodiment of the lighted USB.

FIG. 9 shows a sectional view from the bottom of the preferred embodiment of the lighted USB.

FIG. 10 shows another sectional view from the right side of the preferred embodiment of the lighted USB.

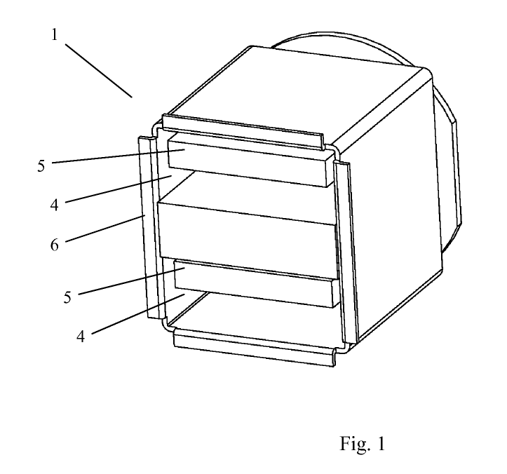

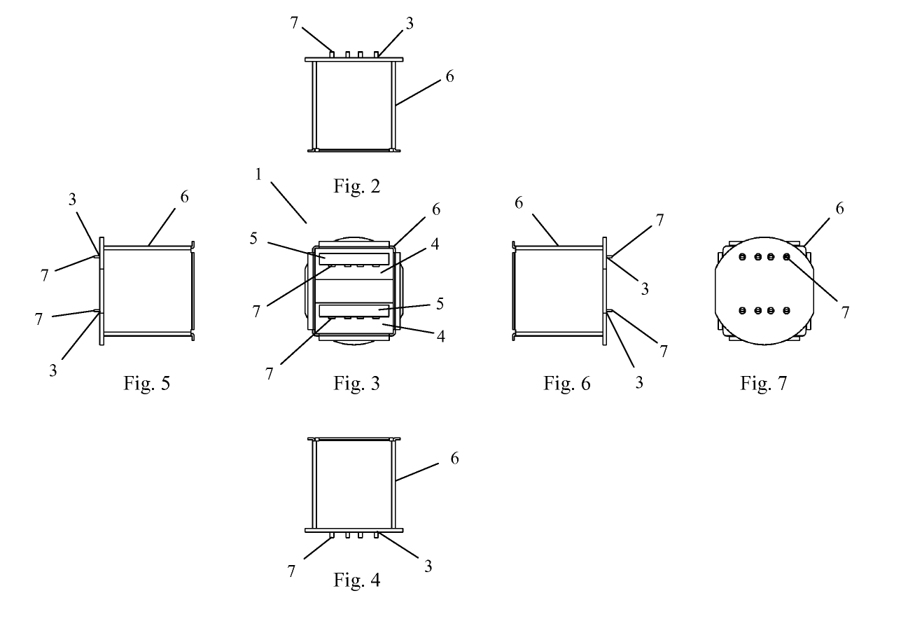

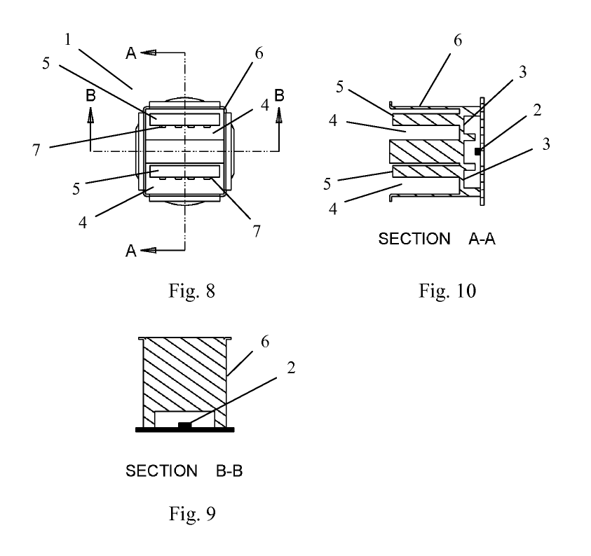

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

As shown in the figures, in the preferred embodiment, the lighted USB comprises a standard dual female USB ports 1 with a light emitting diode (LED) 2 disposed immediately behind the USB ports 1. The LED 2 illuminates the USB ports 1 through the white plastic 5 and the existing openings 3 at the back of the USB ports 1. The USB ports 1 are illuminated without the use of any light pipe. No modification to existing USB port design is required.

A standard female USB port 1 has a rectangular opening 4 with a biased opaque white plastic tongue 5 that is enclosed in a metal sheath 6. There are four electrical contacts 7 on the opaque white plastic tongue 5 that extend through four openings 3 in the back of the opaque white plastic tongue 5 and connect to power and data connections. The LED 2 is positioned behind the opaque white plastic tongue 5 and the four existing openings 3 and illuminates the interior of the USB port 1 through the opaque white plastic and the four existing openings 3. No light pipe is necessary. Furthermore, no additional space on the face area is required around the USB port 1 for the LED 2.

The LED 2 is electrically connected to the 5V power connections behind the USB port 1. When power is available through the power connections, the LED 2 will be illuminated, thereby illuminating the interior of the USB port 1. When power is not available through the power connections, the LED 2 will not be illuminated. The availability of power at the USB port 1 is easily identified by observing the illumination of the USB port 1. After a USB plug is inserted into the USB port 1, the light will be blocked and not be visible.

The lighted USB port enables the USB port 1 to be easily located in low light or dark environments. No modification to existing USB port design is required. The lighted USB port design can be easily retrofitted to existing USB ports without modification of the USB port. Furthermore, since the USB port 1 is illuminated from within the port itself, this design does not take up any front panel space. In addition, since no light pipe is required, this design is compact and takes up very little space behind the USB port 1. The lighted USB can also indicate its power status with an illuminated port indicating power on and a dark port indicating power off.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A lighted universal serial bus comprising:
a standard universal serial bus port with an interior area, a front side, and a rear side wherein said rear side has one or more openings; and
an illumination means provided adjacent to said one or more openings in said rear side whereby said illumination means illuminates said interior area of the standard universal serial bus port.

2. A lighted USB as in claim 1, wherein an opaque white plastic is enclosed in said universal serial bus port.

3. A lighted USB as in claim 1 wherein said rear side has four openings.

4. A lighted USB as in claim 1 wherein said illumination means is a light emitting diode.

5. A lighted USB as in claim 1 wherein said illumination means illuminates the interior area of said universal serial bus port through said one or more openings.

6. A lighted USB as in claim 5 wherein said illumination means illuminates the interior area of said universal serial bus port without any light pipe.

7. A lighted USB as in claim 1, wherein said illumination means is illuminated when power is available through the universal serial bus port and wherein said illumination means is not illuminated when power is not available through the universal serial bus port.

8. A lighted universal serial bus comprising:
a standard universal serial bus port with an interior area, an opaque white plastic affixed in said interior area, a front side, and a rear side wherein said rear side has four openings; and
a light emitting diode provided adjacent to said four openings in said rear side to illuminate the interior area of said standard universal serial bus port without using any light pipe.

9. A lighted USB as in claim 8 wherein said light emitting diode is illuminated when power is available through the universal serial bus port and wherein said light emitting diode is not illuminated when power is not available through the universal serial bus port.

10. A method to retrofit an existing standard universal serial bus with illumination means comprising adding an illumination means to a rear side of a standard universal serial bus to illuminate an interior area of the standard universal serial bus through one or more preexisting openings in said rear side of the standard universal serial bus.

11. A method to retrofit an existing standard universal serial bus with illumination means as in claim 10 wherein an opaque white plastic is affixed in said standard universal serial bus.

12. A method to retrofit an existing standard universal serial bus with illumination means as in claim 10 wherein said rear side has four openings.

13. A method to retrofit an existing standard universal serial bus with illumination means as in claim 10 wherein said illumination means is a light emitting diode.

14. A method to retrofit an existing standard universal serial bus with illumination means as in claim 10 wherein said illumination means illuminates the interior area of said standard universal serial bus without any light pipe.

15. A method to retrofit an existing standard universal serial bus with illumination means as in claim 10 wherein said illumination means is illuminated when power is available through the universal serial bus and wherein said illumination means is not illuminated when power is not available through the universal serial bus.
